(19) United States
(12) Patent Application Publication
(10) Pub. No.: US 2009/0172214 A1
(43) Pub. Date: Jul. 2, 2009

(54) USB HOST CONTROLLER

(75) Inventor: Steve McGowan, Portland, OR (US)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/968,047

(22) Filed: Dec. 31, 2007

(51) Int. Cl. G06F 13/42

(52) U.S. Cl. 710/29

(57) ABSTRACT

In some embodiments, a USB host controller interface interfaces with a USB device at a device level by presenting a pipe of the USB device as a work queue to system software. Other embodiments are described and claimed.

### TECHNICAL FIELD

The inventions generally relate to a USB host controller.

### BACKGROUND

The inventions generally relate to a USB host controller. Universal Serial Bus (USB) host controllers (HCs) typically act as simple data pumps that process system software defined periodic and asynchronous schedules in host memory to generate all USB transfer activity. Every 125 us, the HC evaluates the periodic schedule for interrupt and isochronous transfers to execute. For asynchronous transfers the schedule can be evaluated as often as every 10 us, This evaluation requires fetching schedule data structures from host memory. A key problem associated with the short periods between host memory references to schedule data structures is that they prevent the memory subsystem from ever entering reduced power states. The processor snoops generated on these references also prevent the CPU from entering a reduced power state.

Since USB is a master/slave bus, the host controller manages all transfers to devices. That is, USB devices never asynchronously generate packets on the bus, they must be polled by the host. The USB “interrupt” pipe implementation actually requires that the HC poll a device to query for interrupt data. If a device has no interrupt data to report, which is usually the case, it will NAK the request, only returning an ACK and data when an “interrupt” has occurred.

In an idle system where the user expects to bump the mouse to exit the screen saver, for example, system software sets up the periodic schedule to continuously poll the interrupt pipe of the mouse looking for an ACK that indicates mouse movement This polling prevents the processor and memory from entering a low power state, even though no data is being returned by the mouse for long periods of time.

Another characteristic of current USB HC architectures is that each version of HC is designed to support specific device speeds (UHCI or USB Host Controller Interface for low-speed and full-speed devices, and EHCI or Enhanced Host Controller Interface for high-speed devices). Each USB speed has unique timing, packet size, and protocol requirements that are reflected in the respective schedule data structures in host memory, hence requiring a unique driver implementation for each speed.

Current HC architecture does not play well with virtualization. The typical approach for sharing resources in a virtualized environment is for the Service Virtual Machine (SVM) to provide a register level emulation of the hardware that a Guest Virtual Machine (GVM) expects to see. Since each GVM USB bus driver assumes that it owns the full resources of the USB associated with an HC, conflicts arise when that underlying bus (and the devices on it) is actually shared between several GVMs. The alternative is “para-virtualized” drivers, where new USB drivers are loaded on to the GVMs, which know that they are running in a virtualized environment. Both alternatives incur serious performance impacts. Therefore, the present inventors have identified a need for a new type of USB HC.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

### DETAILED DESCRIPTION

Some embodiments of the inventions relate to a USB host controller.

In some embodiments, a USB host controller interface interfaces with a USB device at a device level by presenting a pipe of the USB device as a work queue to system software.

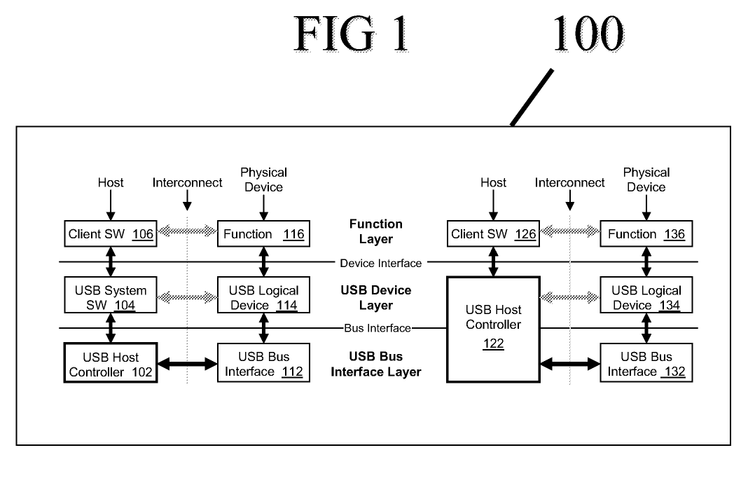

FIG. 1 illustrates a system 100 according to some embodiments. The system on the left side of FIG. 1 illustrates a typical Universal Serial Bus (USB) host controller (HC) implementation while the system 100 on the right side of FIG. 1 illustrates a system according to some embodiments.

The typical USB system on the left side of FIG. 1 includes a USB HC 102, USB system software 104, and client software 106 on a host side, and a USB bus interface 112, a USB logical device 114, and a function 116 of a USB device on a physical device side. Connection arrows between USB HC 102 and USB system software 104, between USB system software 104 and client software 106, between USB HC 102 and USB bus interface 112, between USB bus interface 112 and USB logical device 114, and between USB logical device 114 and function 116 all illustrate actual communication flow. Connection arrow between USB system software 104 and USB logical device 114, and between client software 106 and function 116 illustrate logical communication flow.

In some embodiments, the USB system 100 on the right side of FIG. 1 includes a USB HC 122 and client software 126 on a host side, and a USB bus interface 132, a USB logical device 134, and a function 136 of a USB device on a physical device side. Connection arrows between USB HC 122 and client software 126, between USB HC 122 and USB bus interface 132, between USB bus interface 132 and USB logical device 134, and between USB logical device 134 and function 136 all illustrate actual communication flow. Connection arrows between USB HC 122 and USB logical device 134, and between client software 126 and function 136 illustrate logical communication flow. As illustrated in FIG. 1, the USB HC 122 of system 100 at the right side of FIG. 1 extends the hardware interface for the USB host controller to the device interface level.

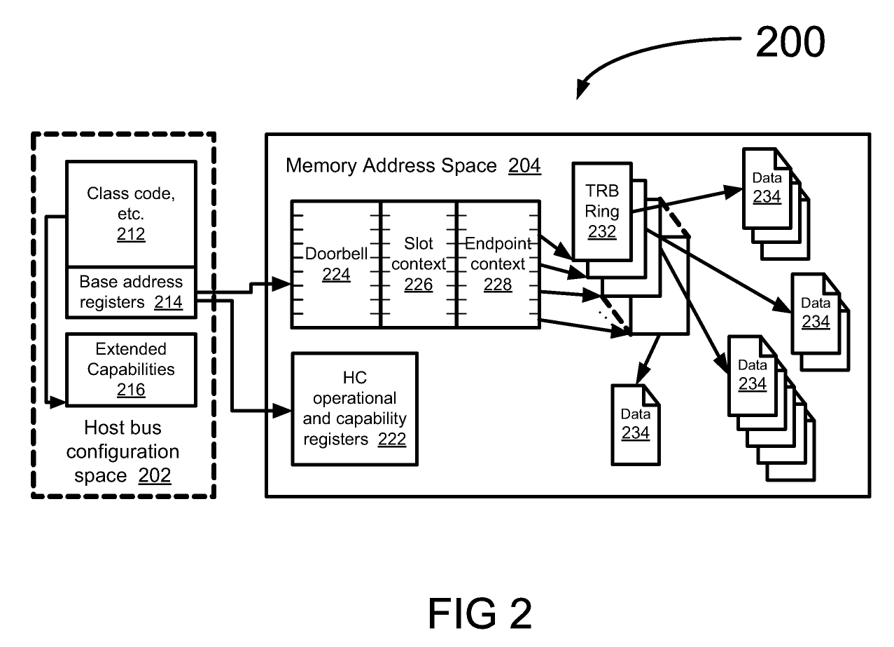

FIG. 2 illustrates a system 200 according to some embodiments. System 200 includes a host bus configuration space 202 and a memory address space 204. Host bus configuration space 202 includes class code 212, base address registers 214, and extended capabilities 216. Memory address space 204 includes host controller (HC) operational and capability registers 222, device slot components such as doorbells 224, slot contexts 226, and endpoint contexts 228, Transfer Request Block (TRB) rings 232, and data 234. The host bus configuration space 202 provides access to the HC operational and capability registers 222, and to the device slot components of doorbells 224, slot contexts 226, and endpoint contexts 228. The endpoint contexts point to the TRB rings, which in turn point to the data 234.

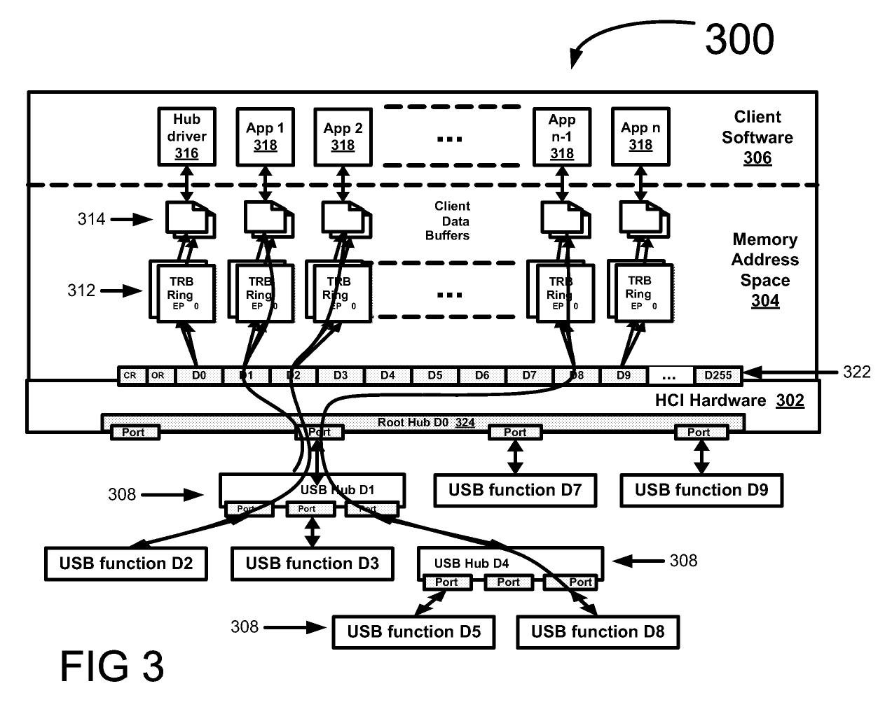

FIG. 3 illustrates a system 300 according to some embodiments. System 300 includes Host Controller Interface (HCI) hardware 302, a memory address space 304, client software 306, and a plurality of USB devices 308 (for example, in some embodiments, including USB functions and hubs such as USB Hub D1, USB function D2, USB function D3, USB hub D4, USB function D5, USB function D7, USB function D8, and USB function D9). Memory address space 304 includes, for example, a plurality of Transfer Request Block (TRB) rings 312 and a plurality of client data buffers 314. Client software 306 includes, for example, a hub driver 316 and a plurality of applications 318 (for example, app 1, app 2, . . . , app n-1, app n). USB HCI 302 presents a homogeneous array of device slots 322 (D0, D1, D2, D255) to system software, and device slot 0 exposes a root hub 324. FIG. 3 illustrates how USB devices 308 are mapped to the device slots 322. Pipes are supported between a USB device 308 and client software 306 owned data buffers 314. Three pipes are illustrated by arrows in FIG. 3 (for example, one pipe between USB function D2 and the client data buffer 314 coupled to app 2, one pipe between USB function D8 and the client data buffer 314 coupled to app n-1, and one pipe between USB hub D1 and the client data buffer 314 coupled to app 1).

In some embodiments the USB HCI provides an interface to the USB devices attached to the system, presents a homogeneous array of device slots to the system software, and presents host bus specific enumeration, interrupt, and power management mechanisms (for example, for a system that supports PCI Express, configuration space, MSI or MSI-X, and PMI).

In some embodiments, device slots include slot contexts, endpoint contexts, and doorbells. A slot context defines general information that is with a USB device or HC device slot. An endpoint context defines information that is associated with a specific pipe of a device. Doorbells are used to notify the HC when system software modifies the slot or endpoint context of a device. Device slots are allocated to each device that is attached. Device slot 0 exposes a root hub. Device slots reside on page boundaries so that they can be arbitrarily mapped to Guest Virtual Machines (GVMs). The HC presents a doorbell for each device slot, which system software “rings” to notify the HC of changes to the slot context. One to one mapping of device slots with root hub ports simplifies enumeration.

In some embodiments, the endpoint context associated with each pipe defines a ring (or circular queue) in host memory. The ring defines the workload associated with a pipe. As mentioned above, the HC presents a doorbell for each pipe, which system software “rings” to notify the HC of changes to the endpoint context. There is a one to one mapping of a pipe to a physical endpoint on a USB device. Three pipe modes are supported, including IN, OUT, and Bidirectional. Four levels of service are supported, including isochronous, interrupt, bulk, and control. These pipes correspond to the pipes defined by the USB Framework.

In some embodiments, system software places work items in the form of Transfer Descriptors (TDs) on a pipe's ring for execution by the HC. TD ownership (that is, system software ownership vs. HC ownership) is defined by head and tail offsets. System software updates head offset and “rings” the associated doorbell when TDs are added to the list. The HC updates tail offset (and interrupts the host if instructed) when TDs are completed. The ring allows multiple TDs to be added or completed in a single operation, enables TD read-ahead, and can be extended across non-contiguous memory pages.

In some embodiments, the Transfer Descriptor (TD) defines a single transfer (message) between a USB device and system software. A TD consists of one or more Transfer Request Blocks (TRBs). In some embodiments, TRBs point to data buffers which contain the information that will be transmitted over or received by a pipe. TRBs contain control flags which allow system software to identify TRBs of interest (a host interrupt can be generated on an individual TRB). A flexible definition of TRBs supports all pipe types.

In some embodiments, an array of device slots that reside in host memory are used, where each slot represents a single USB device. A device slot includes context and doorbells. The context is accessible through the host memory address space, implemented either as data structures in main memory or as registers in memory mapped IO space.

The USB data flow model describes pipes that define communication flows between buffers owned by client software and endpoints that reside in a USB device. A pipe represents the data communication flow between client software buffers and device endpoints. For a USB device, a device slot provides a direct mapping between rings that point to client software buffers and the device's endpoints (for example, knowing a device's endpoint address, system software can directly access the associated ring (work item list) in a device slot.

Client software communicates with a USB device at the “device interface level” (see, for example, FIG. 1) by placing Transfer Descriptors or TDs (for example, work items) on the rings owned by the device, and checking the TD status when a completion interrupt is received.

As part of a host controller initialization, a host bus specific enumeration process discovers and performs generic configuration to allow the HC to communicate over the host bus with system software. System software then takes over and completes the HC initialization process by configuring the interrupt handlers, the root hub, and the HC specific features.

Device slot 0 is unique, since it is always used to present a root hub. The root hub is used to enumerate devices attached to root hub ports. The root hub is permanently attached to the HC, so it does not generate a port status change event to announce its arrival. System software knows to enumerate it as part of the HC initialization process. However, the root hub is enumerated in the same way that any other USB device is enumerated (for example, the same way as in device slot initialization). As with any USB hub, when a device “attach” event is detected on a root hub port, the root hub generates a port status change interrupt. System software uses this interrupt to trigger a device slot initialization.

When a USB device attach event is detected, system software selects a device slot and initializes its slot and endpoint 0 context. System software then communicates with the device through the control endpoint (0) to receive the device's capabilities and assigns the device to the appropriate client software, which is capable of managing the application specific functionality of the device.

Through a device's control endpoint, client software will then retrieve the capabilities of the device, determine a specific configuration for run-time operation, initialize the device slot endpoint context for the endpoints defined by that configuration, and issue a set configuration request to the device. The device is not ready for normal operation.

The USB Specification defines the USB Device Framework, which identifies how data is moved across USB. The Device Framework defines an interface that is a level above the signaling and protocol definitions of the USB. According to the Device Framework, even though the physical and logical topology of the USB reflects the shared nature of the bus, client software manipulating a USB function interface is presented with the view that it deals only with its interface(s) of interest. Client software is not aware of bus topology.

The Device Framework provides a communication service between software on the host and its USB function. Functions can have different communication flow requirements for different client-to-function interactions, and the Device Framework provides better overall bus utilization by allowing the separation of the different communication flows to a USB function. Logical partitioning is maintained between the USB bus interface, USB Logical devices, and function of the USB device.

In some embodiments, a hardware interface to USB is implemented that presents a framework-level abstraction of the USB and the devices attached to it. The features of this USB Framework-level abstraction by hardware are that it eliminates legacy HC schedules and associated memory activity, constrains host memory accesses to real work by eliminating idle-time schedule memory activity, reduces system power consumption, and enables power management innovation. Additionally, it hides low-level USB packet, timing and protocol constraints of individual USB protocols from system software, enables support for all USB speeds through a single interface, enables the elimination of the current low-speed/high-speed companion controllers, and enables seamless adoption of new higher speed USB architectures. It also provides support for virtualization of USB devices, enables Direct-Assignment of USB devices to VMs, and enables system level management of USB bandwidth and address assignment.

An example of an idle system where the user expects to bump the mouse to exit the screen saver is described below. For example, a driver for this Framework-level interface posts a buffer to the work queue for the interrupt pipe in host memory, and then writes to the associated doorbell register on the HC to indicate that a buffer is available for interrupt data. After reading the work queue entry, the host controller internally schedules the USB polling of the device's interrupt pipe, and only accesses host memory again to copy interrupt data returned by an ACK from the device. The NAK activity generated by the device when it does not have interrupt data to send does not generate any host memory references. Hence, once a buffer is posted to the HC and the HC reads the work queue entry from memory, there will be no memory activity until the data is actually moved

In some embodiments, USB transaction scheduling algorithms are move into hardware. This architecture allows, for example, improving USB power management as part of the computer platform rather than relying on software and release schedules thereof. In this manner, for example, chipset USB protocol/speed enhancements are decoupled from OS vendor release cycles.

In some embodiments, a device-level system hardware interface to USB devices is implemented. USB virtualizing is improved and software overhead incurred with current virtualization techniques is removed. In some embodiments, hardware representation of pipes of a USB device as a collection of work queues to system software is implemented.

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a USB host controller interface to interface with a USB device at a device level by presenting a pipe of the USB device as a work queue to system software.

2. The apparatus of claim 1, further comprising one or more device slots in host memory, where the USB device is represented by one of the device slots.

3. The apparatus of claim 2, wherein the one or more device slots include context and doorbells.

4. The apparatus of claim 2, wherein one of the device slots is used to present a root hub.

5. The apparatus of claim 1, wherein the pipe defines communication flow between a buffer owned by software and an endpoint in the USB device.

6. The apparatus of claim 1, wherein the USB host controller interface hides low-level USB packet, timing and protocol constraints of the individual USB protocols from system software.

7. The apparatus of claim 1, wherein the USB host controller interface supports virtualization of USB devices.

8. A method comprising:
interfacing with a USB device at a device level; and
presenting a pipe of the USB device as a work queue to system software.

9. The method of claim 8, further comprising storing one or more device slots in host memory, where the USB device is represented by one of the device slots.

10. The method of claim 9, wherein the one or more device slots include context and doorbells.

11. The method of claim 9, further comprising using one of the device slots present a root hub.

12. The method of claim 8, wherein the pipe defines communication flow between a buffer owned by software and an endpoint in the USB device.

13. The method of claim 8, further comprising hiding low-level USB packet, timing and protocol constraints of the individual USB protocols from system software.

14. The method of claim 8, further comprising supporting virtualization of USB devices.
